(19) United States
(12) Patent Application Publication
(10) Pub. No.: US 2015/0312579 A1
(43) Pub. Date: Oct. 29, 2015

(54) VIDEO ENCODING AND DECODING METHOD AND DEVICE USING SAID METHOD

(71) Applicant: INTELLCTUAL DISCOVERY CO., LTD., Seoul (KR)

(72) Inventors: Dong Gyu SIM, Seoul (KR); Hyun Ho JO, Seoul (KR); Sung Eun YOO, Seoul (KR)

(73) Assignee: INTELLECTUAL DISCOVERY CO., LTD., Seoul (KR)

(21) Appl. No.: 14/648,077

(22) PCT Filed: Dec. 4, 2013
(86) PCT No.: PCT/KR2013/011143

§ 371 Date: May 28, 2015

(30) Foreign Application Priority Data
Dec. 4, 2012 (KR) 10-2012-0139405
Apr. 24, 2013 (KR) 10-2013-0045297
Apr. 24, 2013 (KR) 10-2013-0045302
Apr. 24, 2013 (KR) 10-20130045307

(51) Int. Cl. H04N 19/187; G06T 3/40; H04N 19/176; H04N 19/527; G06T 7/00; H04N 19/423; G06T 5/00

(52) U.S. Cl. CPC H04N 19/187; H04N 19/423; G06T 3/40; G06T 5/003; H04N 19/527; G06T 7/0051; H04N 19/176

(57) ABSTRACT

The present invention minimizes the clipping of a pixel value in upsampling and interpolation filter processes in reference to a restoration image of a reference layer by an enhancement layer in an SVC decoder and thus minimizes a decrease in picture quality. Also, by adjusting and limiting the motion vector of the enhancement layer to the position of an integer pixel when deriving a differential coefficient of the reference layer by using a motion vector of the enhancement layer in the GRP process, it is possible to create a differential coefficient without performing additional interpolation on the image of the reference layer.

### BACKGROUND OF THE INVENTION

1. Field of the Invention

The present invention relates to image processing technology, and more specifically, to methods and apparatuses for more efficiently compressing enhancement layers using restored pictures of reference layers in inter-layer video coding.

2. Related Art

Conventional video coding generally codes and decodes one screen, resolution, and bit rate appropriate for application and serves the same. With the development of multimedia, there are ongoing standardization and related research on the scalable video coding (SVC) that is the video coding technology supportive of diversified resolutions and image qualities dependent on the time space according to various resolutions and applicable environments and the multi-view video coding (MVC) that enables representation of various views and depth information. The MVC and SVC are referred to as extended video coding/decoding.

H.264/AVC, the video compression standard technology widely used in the market, also contains the SVC and MVC extended video standards, and High Efficiency Video Coding (HEVC), whose standardization was complete on January, 2013, is also underway for standardization on extended video standard technology.

The SVC enables coding by cross-referencing images with one or more time/space resolutions and image qualities, and the MVC allows for coding by multiple images cross-referencing one another. In this case, coding on one image is referred to as a layer. While existing video coding enables coding/decoding by referencing previously coded/decoded information in one image, the extended video coding/decoding may perform coding/decoding through referencing between different layers of different views and/or different resolutions as well as the current layer.

Layered or multi-view video data transmitted and decoded for various display environments should support compatibility with existing single layer and view systems as well as stereoscopic image display systems. The ideas introduced for the purpose are base layer or reference layer and enhancement layer or extended layer, and from a perspective of multi-view video coding, base view or reference view and enhancement view or extended view. If some bitstream has been coded by a HEVC-based layered or multi-view video coding technique, in the process of decoding the bitstream, at least one base layer/view or reference layer/view may be correctly decoded through an HEVC decoding apparatus. In contrast, an extended layer/view or enhancement layer/view, which is an image decoded by referencing the information of another layer/view, may be correctly decoded after the information of the referenced layer/view comes up and the image of the layer/view is decoded. Accordingly, the order of decoding should be followed in compliance with the order of coding of each layer/view.

The reason why the enhancement layer/view has dependency on the reference layer/view is that the coding information or image of the reference layer/view is used in the process of coding the enhancement layer/view, and this is denoted inter-layer prediction in terms of layered video coding and inter-view prediction in terms of multi-view video coding. Inter-layer/inter-view prediction may allow for an additional bit saving by about 20 to 30% as compared with the general intra prediction and inter prediction, and research goes on as to how to use or amend the information of reference layer/view for the enhancement layer/view in inter-layer/inter-view prediction. Upon inter-layer reference in the enhancement layer for layered video coding, the enhancement layer may reference the restored image of the reference layer, and in case there is a gap in resolution between the reference layer and the enhancement layer, up-sampling may be conducted on the reference layer upon referencing.

### SUMMARY OF THE INVENTION

The present invention aims to provide an up-sampling and interpolation filtering method and apparatus that minimizes quality deterioration upon referencing the restored image of the reference layer in the coder/decoder of the enhancement layer.

Further, the present invention aims to provide a method and apparatus for predicting a differential coefficient without applying an interpolation filter to the restored picture of the reference layer by adjusting the motion information of the enhancement layer upon prediction-coding an inter-layer differential coefficient.

According to a first embodiment of the present invention, an inter-layer reference image generating unit includes an up-sampling unit; an inter-layer reference image middle buffer; an interpolation filtering unit; and a pixel depth down-scaling unit.

According to a second embodiment of the present invention, an inter-layer reference image generating unit includes a filter coefficient inferring unit; an up-sampling unit; and an interpolation filtering unit.

According to a third embodiment of the present invention, an enhancement layer motion information restricting unit abstains from applying an additional interpolation filter to an up-scaled picture of the reference layer by restricting the accuracy of the motion vector of the enhancement layer upon predicting an inter-layer differential signal.

According to the first embodiment of the present invention, an image of an up-sampled reference layer is stored, to a pixel depth by which it does not get through down-scaling, in the inter-layer reference image middle buffer, and in some cases, it undergoes M-time interpolation filtering and is then down-scaled to the depth of the enhancement layer. The finally interpolation-filtered image is clipped with a depth value of pixel, minimizing a deterioration of pixels that may arise in the up-sampling or a middle process of the interpolation filtering.

According to the second embodiment of the present invention, a filter coefficient with which the reference layer image is up-sampled and interpolation-filtered may be inferred so that up-sampling and interpolation filtering may be conducted on the restored image of the reference layer by one-time filtering, enhancing the filtering efficiency.

According to the third embodiment of the present invention, the enhancement layer motion information restricting unit may restrict the accuracy of motion vector of the enhancement layer when predicting an inter-layer differential signal, allowing the restored image of the reference layer to be referenced upon predicting an inter-layer differential signal without applying additional interpolation filtering to the restored image of the reference layer.

### BRIEF DESCRIPTION OF THE DRAWINGS

FIG. 1 is a block diagram illustrating a configuration of a scalable video coder;

FIG. 2 is a block diagram illustrating an extended decoder according to a first embodiment of the present invention;

FIG. 3 is a block diagram illustrating an extended coder according to the first embodiment of the present invention;

FIG. 4a is a block diagram illustrating an apparatus that up-samples and interpolates a restored frame of a reference layer and uses it as a reference value in a scalable video coder/decoder;

FIG. 4b is a block diagram illustrating a method and apparatus that interpolates and up-samples a reference image for inter-layer prediction in the extended coder/decoder according to the first embodiment of the present invention;

FIG. 4c is a block diagram illustrating another method and apparatus that interpolates and up-samples a reference image for inter-layer prediction in the extended coder/decoder according to the first embodiment of the present invention;

FIG. 5 is a concept view illustrating a technology for predicting an inter-layer differential coefficient (Generalized Residual Prediction; GRP) according to a second embodiment of the present invention;

FIG. 6 is a block diagram illustrating an extended coder according to the second embodiment of the present invention;

FIG. 7 is a block diagram illustrating an extended decoder according to the second embodiment of the present invention;

FIG. 8 is a view illustrating a configuration of an up-sampling unit of the extended coder/decoder according to the second embodiment of the present invention;

FIG. 9 is a view illustrating an operation of a motion information adjusting unit of an extended coder/decoder according to a third embodiment of the present invention;

FIG. 10 is a view illustrating an example in which the motion information adjusting unit of the extended coder/decoder maps a motion vector of an enhancement layer to an integer pixel according to the third embodiment of the present invention;

FIG. 11a is a view illustrating another operation of a motion information adjusting unit of an extended coder/decoder according to the third embodiment of the present invention;

FIG. 11b is a view illustrating an example in which the motion information adjusting unit of the extended coder/decoder maps a motion vector of an enhancement layer to an integer pixel using an algorithm for minimizing errors according to the third embodiment of the present invention;

FIG. 12 is a view illustrating another operation of a motion information adjusting unit of an extended coder/decoder according to the third embodiment of the present invention;

FIG. 13 is a view illustrating an enhancement layer reference information and motion information extracting unit according to an embodiment of the present invention;

FIG. 14 is a view illustrating an embodiment of the present invention; and

FIG. 15 is a view illustrating another embodiment of the present invention.

### DETAILED DESCRIPTION OF EXEMPLARY EMBODIMENTS

Hereinafter, embodiments of the present invention are described in detail with reference to the accompanying drawings. When determined to make the subject matter of the present invention unclear, the detailed description of known configurations or functions is omitted.

When an element is “connected to” or “coupled to” another element, the element may be directly connected or coupled to the other element or other elements may intervene. When a certain element is “included,” other elements than the element are not excluded, and rather additional element(s) may be included in an embodiment or technical scope of the present invention.

The terms “first” and “second” may be used to describe various elements. The elements, however, are not limited to the above terms. In other words, the terms are used only for distinguishing an element from others. Accordingly, a “first element” may be named a “second element,” and vice versa.

Further, the elements as used herein are shown independently from each other to represent that the elements have respective different functions. However, this does not immediately mean that each element cannot be implemented as a piece of hardware or software. In other words, each element is shown and described separately from the others for ease of description. A plurality of elements may be combined and operate as a single element, or one element may be separated into a plurality of sub-elements that perform their respective operations. Such also belongs to the scope of the present invention without departing from the gist of the present invention.

Further, some elements may be optional elements for better performance rather than necessary elements to perform essential functions of the present invention. The present invention may be configured only of essential elements except for the optional elements, and such also belongs to the scope of the present invention.

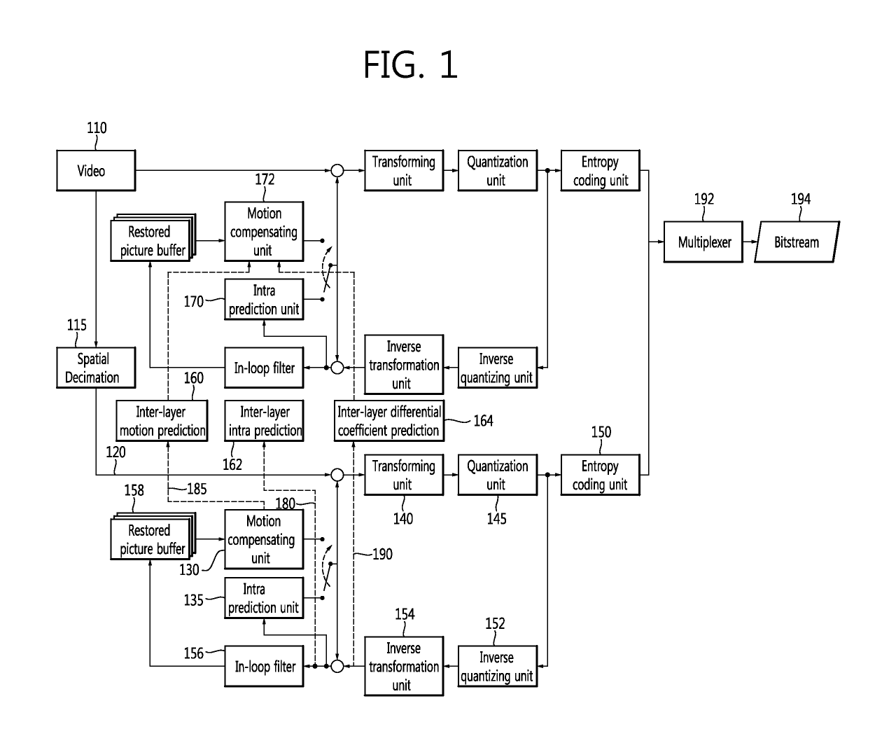

FIG. 1 is a block diagram illustrating the configuration of a scalable video coder.

Referring to FIG. 1, the scalable video coder provides spatial scalability, temporal scalability, and SNR scalability. The spatial scalability adopts a multi-layer scheme using up-sampling, and the temporal scalability adopts the Hierarchical B picture structure. The SNR scalability adopts the same scheme as the spatial scalability except that the quantization coefficient is varied or adopts a progressive coding scheme for quantization errors.

An input video 110 is down-sampled through a spatial decimation 115. The down-sampled image 120 is used as an input to the reference layer, and the coding blocks in the picture of the reference layer are efficiently coded by intra prediction through an intra prediction unit 135 and inter prediction through a motion compensating unit 130. The differential coefficient, a difference between a raw block sought to be coded and a prediction block generated by the motion compensating unit 130 or the intra prediction unit 135, is discrete cosine transformed (DCTed) or integer-transformed through a transformation unit 140. The transformed differential coefficient is quantized through a quantization unit 145, and the quantized, transformed differential coefficient is entropy-coded through an entropy coding unit 150. The quantized, transformed differential coefficient goes through an inverse quantization unit 152 and an inverse transformation unit 154 to generate a prediction value for use in a neighbor block or neighbor picture, and is restored to the differential coefficient. In this case, the restored differential coefficient might not be consistent with the differential coefficient used as the input to the transformation unit 140 due to errors occurring in the quantization unit 145. The restored differential coefficient is added to the prediction block generated earlier by the motion compensating unit 130 or the intra prediction unit 135, restoring the pixel value of the block that is currently coded. The restored block goes through an in-loop filter 156. In case all the blocks in the picture are restored, the restored picture is input to a restored picture buffer 158 for use in inter prediction on the reference layer.

The enhancement layer uses the input video 110 as an input value and codes the same. Like the reference layer, the enhancement layer performs inter prediction or intra prediction through the motion compensating unit 172 or the intra prediction unit 170 to generate an optimal prediction block in order to efficiently code the coded blocks in the picture. A block sought to be coded in the enhancement layer is predicted in the prediction block generated in the motion compensating unit 172 or the intra prediction unit 170, and as a result, a differential coefficient is created on the enhancement layer. The differential coefficient of the enhancement layer, like in the reference layer, is coded through the transformation unit, quantization unit, and entropy-coding unit. In the multi-layer structure as shown in FIG. 1, coding bits are created on each layer, and a multiplexer 192 serves to configure the coding bits into a single bitstream 194.

The multiple layers shown in FIG. 1 may be independently coded. The input video of a lower layer is one obtained by down-sampling the video of a higher layer, and the two have similar characteristics. Accordingly, the coding efficiency may be increased by using the restored pixel value, motion vector, and residual signal of the video of the lower layer for the enhancement layer.

The inter-layer intra prediction 162 shown in FIG. 1, after restoring the image of the reference layer, interpolates the restored image 180 to fit the size of the image of the enhancement layer and uses the same as a reference image. For restoring the image of the reference layer, a scheme decoding the reference image per frame and a scheme decoding the reference image per block may be put to use considering reducing complexity. In particular, in case the reference layer is coded in inter prediction mode, the decoding complexity is high. Accordingly, the H.264/SVC standard permits inter-layer intra prediction only when the reference layer is coded in intra prediction mode. The restored image 180 in the reference layer is input to the intra prediction unit 170 of the enhancement layer, which may increase coding efficiency as compared with use of ambient pixel values in the picture in the enhancement layer.

Referring to FIG. 1, the inter-layer motion prediction 160 references, for the enhancement layer, the motion information 185, such as the reference frame index or motion vector in the reference layer. In particular, since upon performing coding at a low bit rate, the motion information weighs high, referencing such information for the reference layer may lead to enhanced coding efficiency.

The inter-layer differential coefficient prediction 164 shown in FIG. 1 predicts the differential coefficient of enhancement layer with the differential coefficient 190 decoded in the reference layer. By doing so, the differential coefficient of enhancement layer may be more efficiently coded. Following the implementation of the coder, the differential coefficient 190 decoded in the reference layer may be input to the motion compensating unit 172 of the enhancement layer, and the decoded differential coefficient 190 of the reference layer may be considered from the process of motion prediction of the enhancement layer, producing the optimal motion vector.

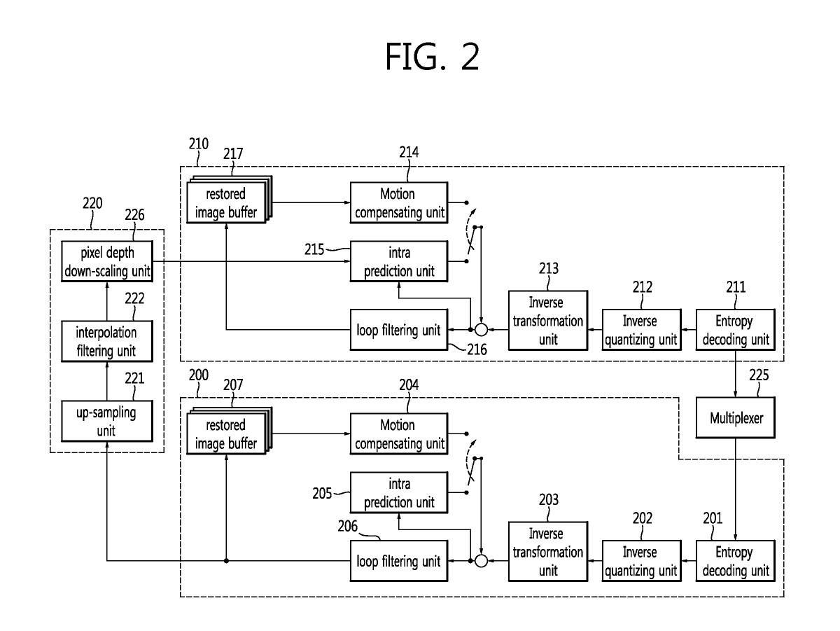

FIG. 2 is a block diagram illustrating an extended decoder according to a first embodiment of the present invention. The extended decoder includes both decoders for the reference layer 200 and the enhancement layer 210. Depending on the number of layers of the SVC, there may be one or more reference layers 200 and enhancement layers 210. The decoder 200 of the reference layer may include, like in the structure of the typical video decoder, an entropy decoding unit 201, an inverse-quantization unit 202, an inverse-transformation unit 203, a motion compensating unit 204, an intra prediction unit 205, a loop filtering unit 206, and a restored image buffer 207. The entropy decoding unit 201 receives a bitstream extracted for the reference layer through the demultiplexing unit 225 and then performs an entropy decoding process. The quantized coefficient restored through the entropy decoding process is inverse-quantized through the inverse-quantization unit 202. The inverse-quantized coefficient goes through the inverse-transformation unit 203 and is restored to the differential coefficient (residual). In case, upon generating a prediction value for a coding block of the reference layer, the coding block has been coded through inter coding, the decoder of the reference layer performs motion compensation through the motion compensating unit 204. Typically, the reference layer motion compensating unit 204, after performing interpolation depending on the accuracy of the motion vector, performs motion compensation. In case the coding block of the reference layer has been coded through intra coding, a prediction value is generated through the intra prediction unit 205 of the decoder. The intra prediction unit 205 generates a prediction value from the ambient pixel values restored in the current frame following intra prediction mode. The prediction value and the differential coefficient restored in the reference layer are added together, generating a restored value. The restored frame gets through the loop filtering unit 206 and is then stored in the restored image buffer 207 and is used in an inter prediction process for a next frame.

The extended decoder including the reference layer and the enhancement layer decodes the image of the reference layer and uses the same as a prediction value in the motion compensating unit 214 and intra prediction unit 215 of the enhancement layer. To that end, the up-sampling unit 221 up-samples the picture restored in the reference layer in consistence with the resolution of the enhancement layer. The up-sampled image is interpolation-filtered through the interpolation filtering unit 222 in consistence with the accuracy of motion compensation, with the accuracy of the up-sampling process remaining the same. The image that has undergone the up-sampling and interpolation filtering is clipped through the pixel depth down-scaling unit 226 into the minimum and maximum values of pixel considering the pixel depth of the enhancement layer to be used as a prediction value.

The bitstream input to the extended decoder is input to the entropy decoding unit 211 of the enhancement layer through the demultiplexing unit 225 and is subjected to parsing depending on the syntax structure of the enhancement layer. Thereafter, passing through the inverse-quantization unit 212 and the inverse-transformation unit 213, a restored differential image is generated, and is then added to the predicted image obtained from the motion compensating unit 214 or intra prediction unit 215 of the enhancement layer. The restored image goes through the loop filtering unit 216 and is stored in the restored image buffer 217, and is used by the motion compensating unit 214 in the process of generating a prediction image with consecutively located frames in the enhancement layer.

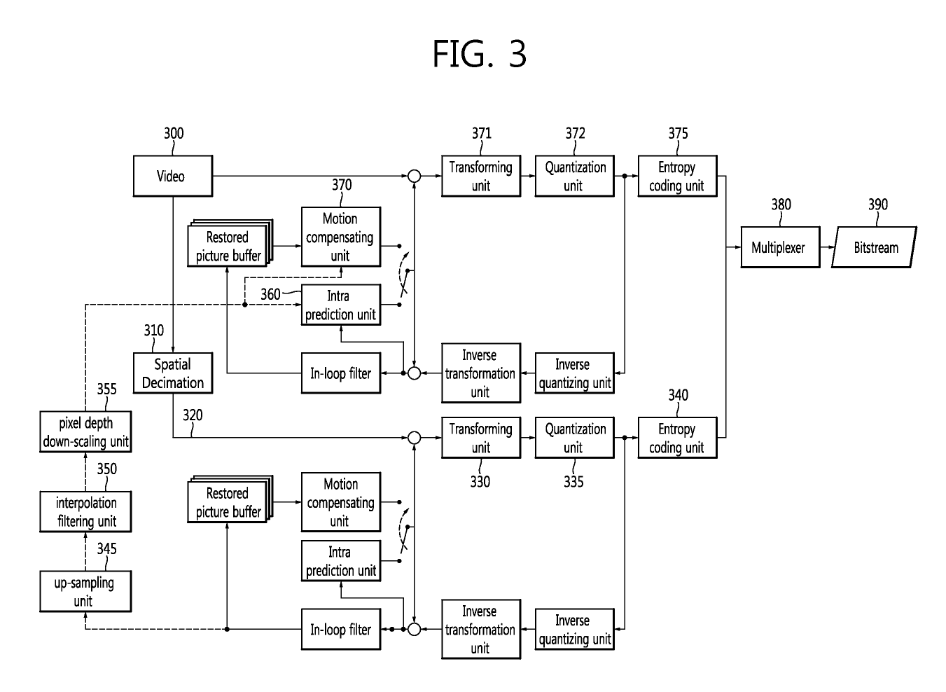

FIG. 3 is a block diagram illustrating an extended coder according to the first embodiment of the present invention.

Referring to FIG. 3, the scalable video encoder down-samples the input video 300 through the spatial decimation 310 and uses the down-sampled video 320 as an input to the video encoder of the reference layer. The video input to the reference layer video encoder is predicted in intra or inter mode per coding block on the reference layer. The differential image, a difference between the raw block and the coding block, undergoes transform-coding and quantizing passing through the transformation unit 330 and the quantization unit 335. The quantized differential coefficients are represented as bits in each unit of syntax element through the entropy coding unit 340.

The encoder for the enhancement layer uses the input video 300 as an input. The input video is predicted through the intra prediction unit 360 or motion compensating unit 370 per coding block on the enhancement layer. The differential image, a difference between the raw block and the coding block, undergoes transform-coding and quantizing passing through the transformation unit 371 and the quantization unit 372. The quantized differential coefficients are represented as bits in each unit of syntax element through the entropy coding unit 3375. The bitstreams encoded on the reference layer and the enhancement layer are configured into a single bitstream through the multiplexing unit 380.

The motion compensating unit 370 and the intra prediction unit 360 of the enhancement layer encoder may generate a prediction value using the restored picture of the reference layer. In this case, the picture of the restored reference layer is up-sampled in consistence with the resolution of the enhancement layer in the up-sampling unit 345. The up-sampled picture is image-interpolated in consistence with the interpolation accuracy of the enhancement layer through the interpolation filtering unit 350. In this case, the filtering unit 350 maintains the accuracy of the up-sampling process with the image up-sampled through the up-sampling unit 345. The image up-sampled and interpolated passing through the up-sampling unit 345 and the interpolation filtering unit 350 is clipped through the pixel depth down-scaling unit 355 into the minimum and maximum values of the enhancement layer to be used as a prediction value of the enhancement layer.

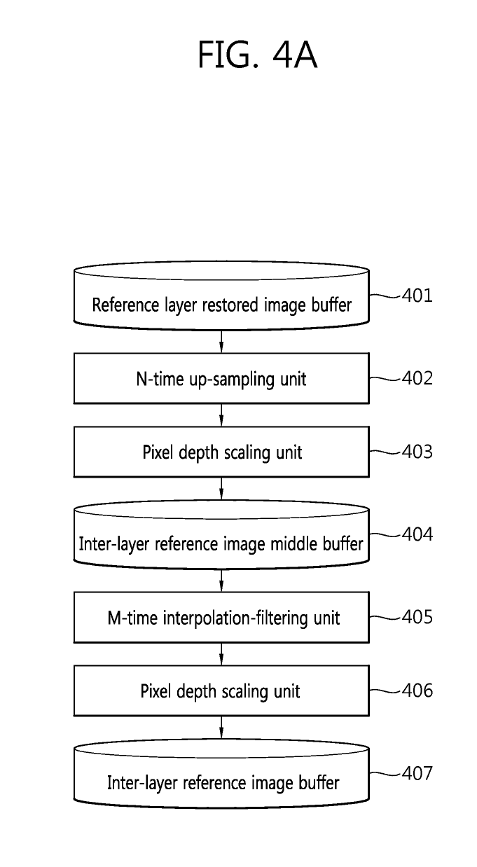

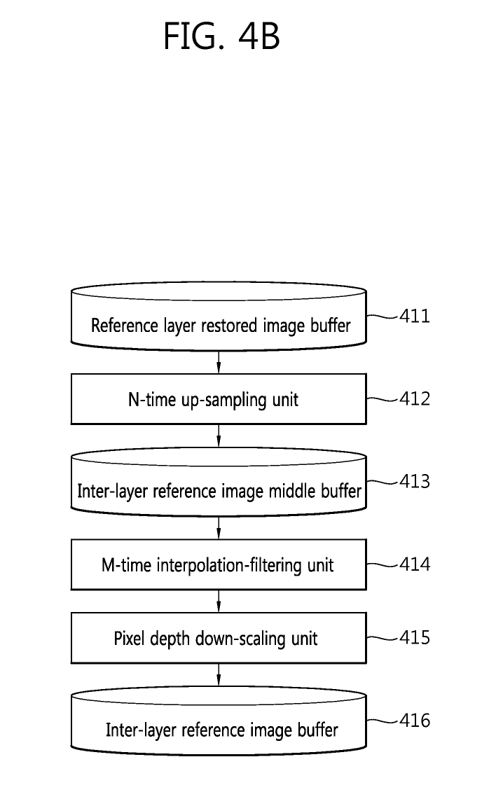

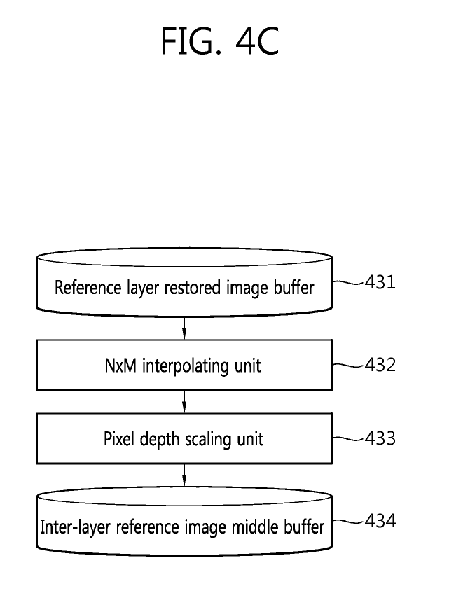

FIG. 4a is a block diagram illustrating an apparatus that up-samples and interpolates a restored frame of a reference layer and uses it as a reference value in a scalable video coder/decoder.

Referring to FIG. 4a, the apparatus includes a reference layer restored image buffer 401, an N-time up-sampling unit 402, a pixel depth scaling unit 403, an inter-layer reference image middle buffer 404, an M-time interpolation-filtering unit 405, a pixel depth scaling unit 406, and an inter-layer reference image buffer 407.

The reference layer restored image buffer 401 is a buffer for storing the restored image of the reference layer. In order for the enhancement layer to use the image of the reference layer, the restored image of the reference layer should be up-sampled to a size close to the image size of the enhancement layer and it is up-sampled through the N-time up-sampling unit 402. The up-sampled image of the reference layer is clipped into the minimum and maximum values of the pixel depth of the enhancement layer through the pixel depth scaling unit 403 and is stored in the inter-layer reference image middle buffer 404. The up-sampled image of the reference layer should be interpolated as per the interpolation accuracy of the enhancement layer to be referenced by the enhancement layer, and is M-time interpolation-filtered through the M-time interpolation-filtering unit 305. The image interpolated through the M-time interpolation-filtering unit 405 is clipped into the minimum and maximum values of the pixel depth used in the enhancement layer through the pixel depth scaling unit 406 and is then stored in the inter-layer reference image buffer 407.

FIG. 4b is a block diagram illustrating a method and apparatus that interpolates and up-samples a reference image for inter-layer prediction in the extended coder/decoder according to the first embodiment of the present invention.

Referring to FIG. 4b, the method and apparatus include a reference layer restored image buffer 411, an N-time up-sampling unit 412, an inter-layer reference image middle buffer 413, an M-time interpolation-filtering unit 414, a pixel depth down-scaling unit 415, and an inter-layer image buffer 416.

The reference layer restored image buffer 411 is a buffer for storing the restored image of the reference layer. In order for the enhancement layer to use the image of the reference layer, the restored image of the reference layer is up-sampled through the N-time up-sampling unit 412 to a size close to the image size of the enhancement layer, and the up-sampled image is stored in the inter-layer reference image middle buffer. In this case, the pixel depth of the up-sampled image is not down-scaled. The image stored in the inter-layer reference image middle buffer 413 is M-time interpolation-filtered through the M-time interpolation-filtering unit 314 in consistence with the interpolation accuracy of the enhancement layer. The M-time filtered image is clipped into the minimum and maximum values of the pixel depth of the enhancement layer through the scaling unit 415 and is stored in the inter-layer reference image buffer 416.

FIG. 4c is a block diagram illustrating another method and apparatus that interpolates and up-samples a reference image for inter-layer prediction in the extended coder/decoder according to the first embodiment of the present invention.

Referring to FIG. 4c, the method and apparatus include a reference layer restored image buffer 431, an N×M-time interpolating unit 432, a pixel depth scaling unit 433, and an inter-layer reference image buffer 434. In order for the enhancement layer to use the image of the reference layer, the restored image of the reference layer should be N times up-sampled to a size close to the image size of the enhancement layer and should be M times interpolation-filtered in consistence with the interpolation accuracy of the enhancement layer. The N×M-time interpolating unit 432 is a step performing up-sampling and interpolation-filtering with one filter. The pixel depth scaling unit 433 clips the interpolated image into the minimum and maximum values of the pixel depth used in the enhancement layer. The image clipped through the pixel depth scaling unit 433 is stored in the inter-layer reference image buffer 434.

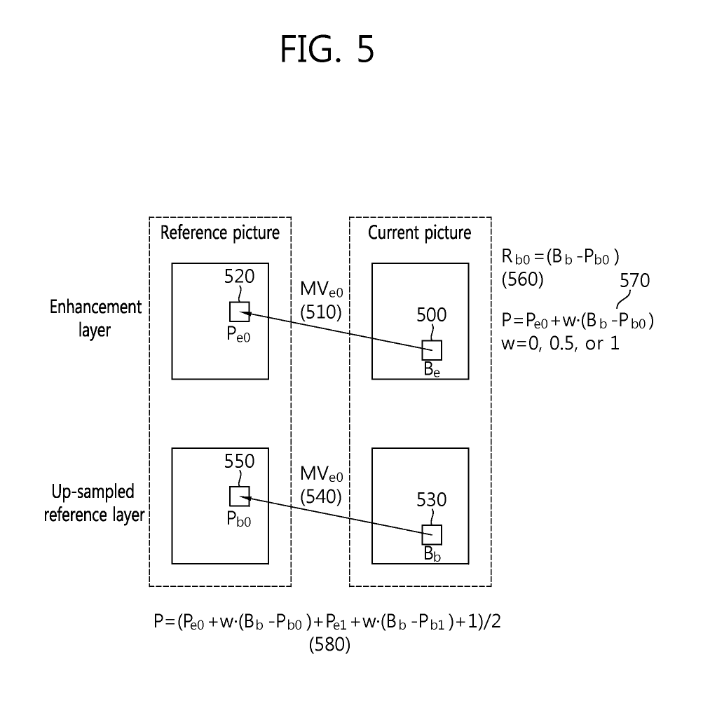

FIG. 5 is a concept view illustrating a technology for predicting an inter-layer differential coefficient (Generalized Residual Prediction; GRP) according to a second embodiment of the present invention.

Referring to FIG. 5, when coding a block 500 of the enhancement layer, the scalable video encoder determines a motion compensation block 520 through uni-lateral prediction. The motion information 510 (reference frame index, motion vector) on the determined motion compensation block 520 is represented through syntax elements. The scalable video decoder obtains the motion compensation block 520 by decoding the syntax elements for the motion information 510 (reference frame index, motion vector) on the block 500 sought to be decoded in the enhancement layer and performs motion compensation on the block.

In the GRP technology, a differential coefficient is induced even in the up-sampled reference layer and the inducted differential coefficient is then used as a prediction value of the enhancement layer. To that end, the coding block 530 co-located with the coding block 500 of the enhancement layer is selected in the up-sampled reference layer. The motion compensation block 550 in the reference layer is determined using the motion information 510 of the enhancement layer with respect to the block selected in the reference layer.

The differential coefficient 560 in the reference layer is calculated as a difference between the coding block 530 of the reference layer and the motion compensation block 550 of the reference layer. In the enhancement layer, the weighted sum 570 of the motion compensation block 520 induced through time prediction in the enhancement layer and the differential coefficient 560 inducted through the motion information of the enhancement layer in the reference layer is used as a prediction block for the enhancement layer. Here, 0, 0.5, and 1 may be selectively used as the weighted coefficient.

Upon use of bi-lateral prediction, the GRP induces a differential coefficient in the reference layer using the bi-lateral motion information of the enhancement layer. The weighted sum of compensation block in the L0 direction in the enhancement layer, differential coefficient in the L0 direction inducted in the reference layer, compensation block in the L1 direction in the enhancement layer, and differential coefficients in the L1 direction inducted in the reference layer is used to calculate the prediction value 580 for the enhancement layer in the bi-lateral prediction.

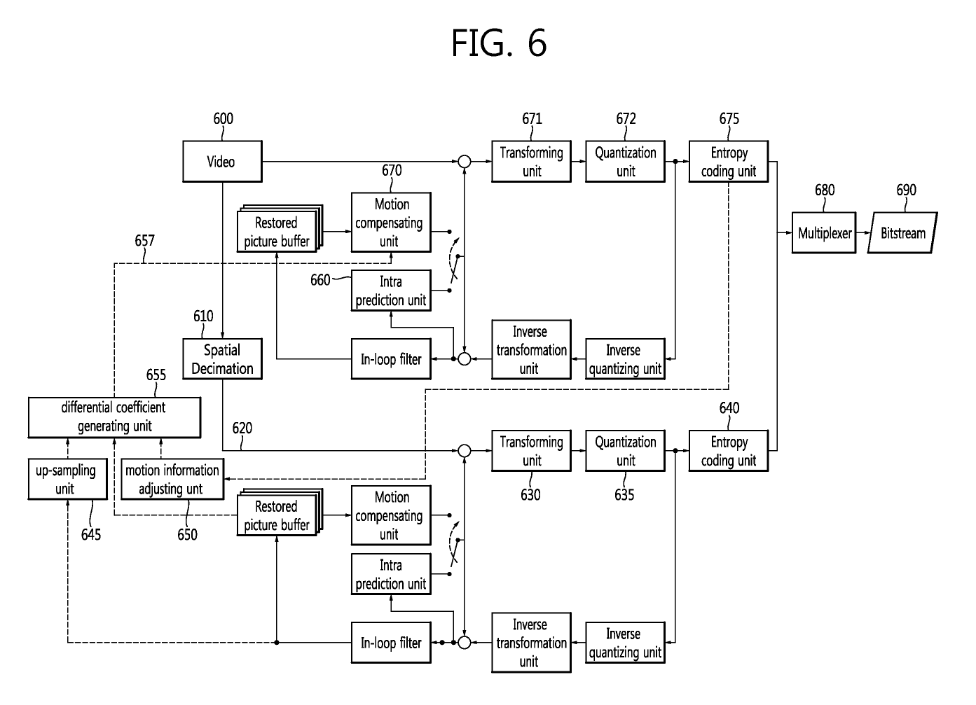

FIG. 6 is a block diagram illustrating an extended coder according to the second embodiment of the present invention.

Referring to FIG. 6, the scalable video encoder down-samples the input video 600 through the spatial decimation 610 and uses the down-sampled video 320 as an input to the video encoder of the reference layer. The video input to the reference layer video encoder is predicted in intra or inter mode per coding block on the reference layer. The differential image, a difference between the raw block and the coding block, undergoes transform-coding and quantizing passing through the transformation unit 630 and the quantization unit 635. The quantized differential coefficients are represented as bits in each unit of syntax element through the entropy coding unit 640.

The encoder for the enhancement layer uses the input video 600 as an input. The input video is predicted through the intra prediction unit 660 or motion compensating unit 670 per coding block on the enhancement layer. The differential image, a difference between the raw block and the coding block, undergoes transform-coding and quantizing passing through the transformation unit 671 and the quantization unit 672. The quantized differential coefficients are represented as bits in each unit of syntax element through the entropy coding unit 675. The bitstreams encoded on the reference layer and the enhancement layer are configured into a single bitstream 690 through the multiplexing unit 680.

In the GRP technology, after up-sampling the image of the reference layer, a differential coefficient in the reference layer is inducted using the motion vector of the enhancement layer, and the inducted differential coefficient is used as a prediction value of the enhancement layer. The up-sampling unit 645 performs up-sampling using the restored image of the reference layer in consistence with the resolution of the image of the enhancement layer. The motion information adjusting unit 650 adjusts the accuracy of the motion vector on a per-integer pixel basis in consistence with the reference layer in order for the GRP to use the motion vector information of the enhancement layer. The differential coefficient generating unit 655 receives the coding block 530 co-located with the coding block 500 of the enhancement layer in the restored picture buffer of the reference layer and receives the motion vector adjusted on a per-integer basis through the motion information adjusting unit 650. The block for generating a differential coefficient in the image up-sampled in the up-sampling unit 645 is compensated using the motion vector adjusted on a per-integer basis. The differential coefficient 657 to be used in the enhancement layer is generated by performing subtraction between the compensated prediction block and the coding block 530 co-located with the coding block 500 of the enhancement layer.

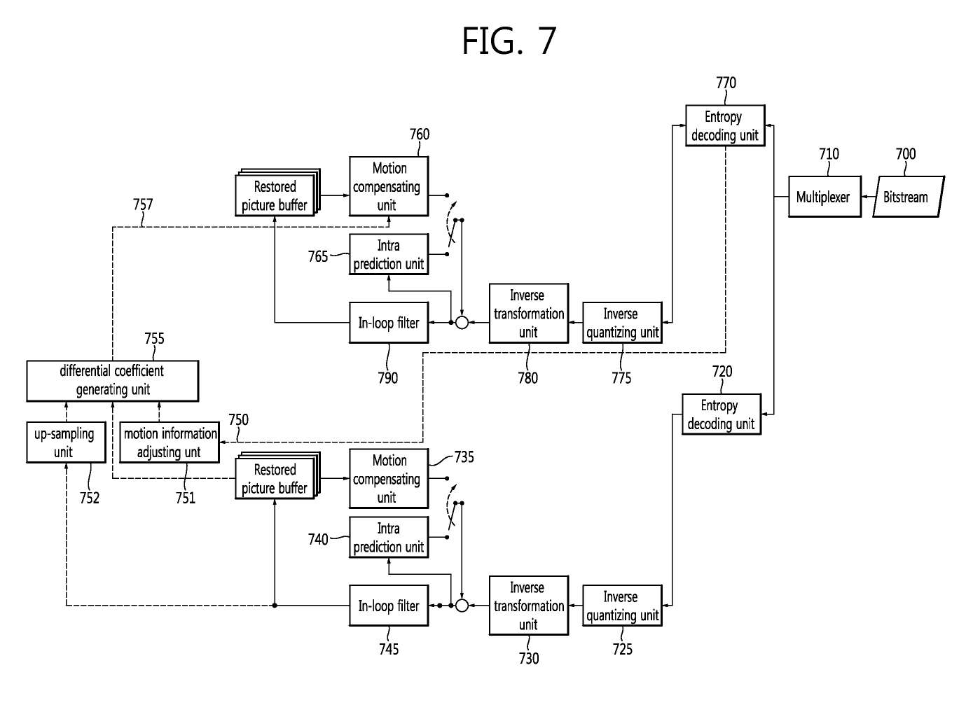

FIG. 7 is a block diagram illustrating an extended decoder according to the second embodiment of the present invention.

Referring to FIG. 7, the single bitstream 700 input to the scalable video decoder is configured into the respective bitstreams for the layers through the demultiplexing unit 710. The bitstream for the reference layer is entropy-decoded through the entropy decoding unit 720 of the reference layer. The entropy-decoded differential coefficient, after going through the inverse-quantization unit 725 and the inverse-transformation unit 730, is decoded to the differential coefficient. The coding block decoded in the reference layer generates a prediction block through the motion compensating unit 735 or the intra prediction unit 740, and the prediction block is added to the differential coefficient, decoding the block. The decoded image is filtered through the in-loop filter 745 and is then stored in the restored picture buffer of the reference layer.

The bitstream of the enhancement layer extracted through the demultiplexing unit 710 is entropy-decoded through the entropy decoding unit 770 of the enhancement layer. The entropy-decoded differential coefficient, after going through the inverse-quantization unit 775 and the inverse-transformation unit 780, is restored to the differential coefficient. The coding block decoded in the enhancement layer generates a prediction block through the motion compensating unit 760 or the intra prediction unit 765 of the enhancement layer, and the prediction block is added to the differential coefficient, decoding the block. The decoded image is filtered through the in-loop filter 790 and is then stored in the restored picture buffer of the enhancement layer.

Upon use of the GRP technology in the enhancement layer, the image of the reference layer is up-sampled and the differential coefficient in the reference layer is then induced using the motion vector of the enhancement layer, and the inducted differential coefficient is used as a prediction value of the enhancement layer. The up-sampling unit 752 performs up-sampling using the restored image of the reference layer in consistence with the resolution of the image of the enhancement layer. The motion information adjusting unit 751 adjusts the accuracy of the motion vector on a per-integer pixel basis in consistence with the reference layer in order for the GRP to use the motion vector information of the enhancement layer. The differential coefficient generating unit 755 receives the coding block 530 co-located with the coding block 500 of the enhancement layer in the restored picture buffer of the reference layer and receives the motion vector adjusted on a per-integer basis through the motion information adjusting unit 751. The block for generating a differential coefficient in the image up-sampled in the up-sampling unit 752 is compensated using the motion vector adjusted on a per-integer basis. The differential coefficient 757 to be used in the enhancement layer is generated by performing subtraction between the compensated prediction block and the coding block 530 co-located with the coding block 500 of the enhancement layer.

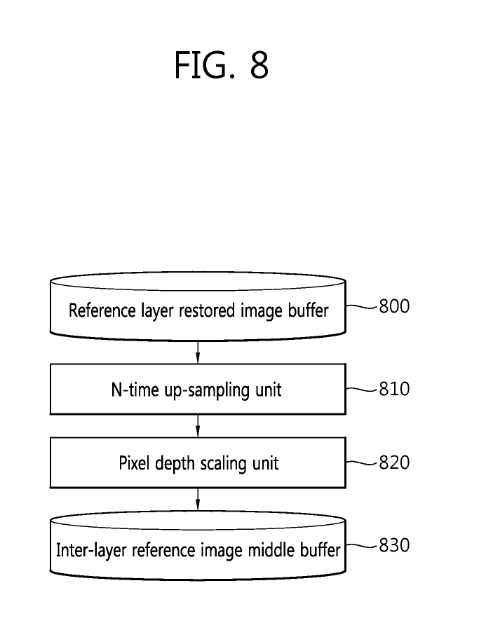

FIG. 8 is a view illustrating the configuration of an up-sampling unit of the extended coder/decoder according to the second embodiment of the present invention.

Referring to FIG. 8, the up-sampling unit 645 or 752 fetches the restored image of the reference layer from the reference layer restored image buffer 800 and up-samples the same through the N-time up-sampling unit 810 in consistence with the resolution of the enhancement layer. Since the up-sampled image may present increased accuracy of pixel value in the up-sampling process, the minimum and maximum values of the pixel depth value of the enhancement layer are clipped through the pixel depth scaling unit 820 and are then stored in the inter-layer reference image buffer 830. The stored image is used when the differential coefficient generating unit 655 or 755 induces a differential coefficient in the reference layer using the adjusted motion vector of the enhancement layer.

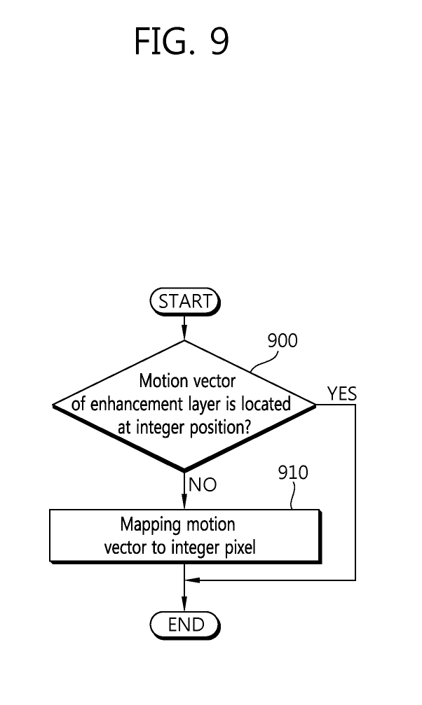

FIG. 9 is a view illustrating the operation of a motion information adjusting unit of an extended coder/decoder according to a third embodiment of the present invention.

Referring to FIG. 9, according to an embodiment of the present invention, the motion information adjusting unit 650 or 751 of the extended coder/decoder adjusts the accuracy of the motion vector of the enhancement layer to an integer position in order for the GRP. In the GRP, the differential coefficient in the reference layer is inducted using the motion vector of the enhancement layer, and in such case, the reference image, after up-sampled, should be interpolated with the accuracy of the motion vector of the enhancement layer. According to an embodiment of the present invention, the extended coder/decoder adjusts the motion vector to the integer position when using the motion vector of the enhancement layer in the GRP, abstaining from interpolation of the image of the reference layer.

The motion information adjusting unit 650 or 751 determines whether the motion vector of the enhancement layer has been already present at the integer position (900). In case the motion vector of the enhancement layer has been already at the integer position, no additional adjustment of motion vector is performed. In case the motion vector of the enhancement layer is not at the integer position, mapping 920 to an integer pixel is performed so that the motion vector of the enhancement layer may be used in the GRP.

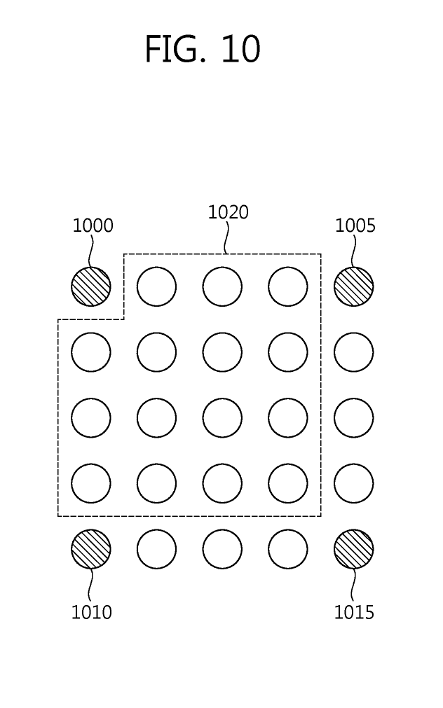

FIG. 10 is a view illustrating an example in which the motion information adjusting unit of the extended coder/decoder maps a motion vector of an enhancement layer to an integer pixel according to the third embodiment of the present invention.

Referring to FIG. 10, the motion vector of the enhancement layer may be located at integer positions 1000, 1005, 1010, and 1015 or at non-integer positions 1020. Upon generating a differential coefficient in the reference layer using the motion vector of the enhancement layer in the GRP, the motion vector of the enhancement layer may be used, mapped to an integer pixel, thus omitting the process of interpolating the image of the reference layer. In case the motion vector of the enhancement layer corresponds to a non-integer position 1020, the motion vector is adjusted to an integer pixel position 1000 located at the left and upper side of the pixel of the non-integer position, and the adjusted motion vector is used in the GRP.

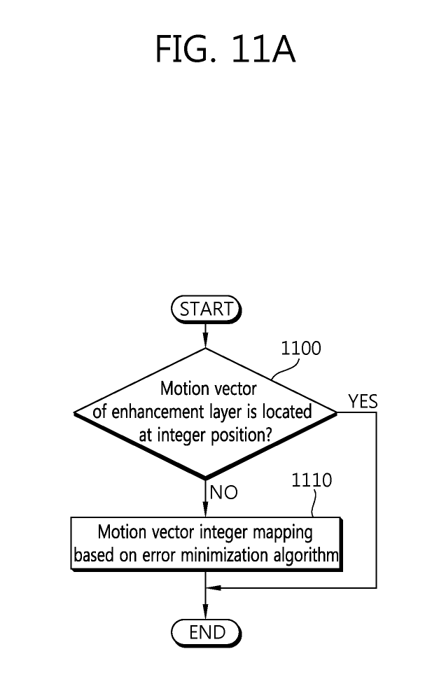

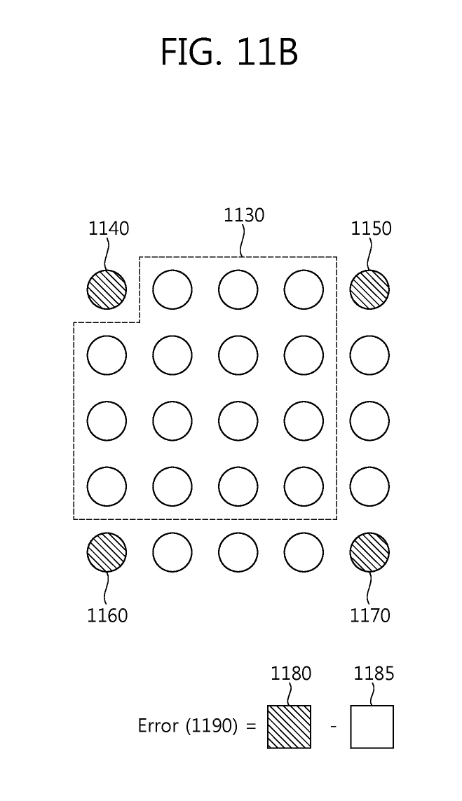

FIG. 11a is a view illustrating another operation of a motion information adjusting unit of an extended coder/decoder according to the third embodiment of the present invention.

Referring to FIG. 11a, according to an embodiment of the present invention, the motion information adjusting unit 650 or 751 of the extended coder/decoder adjusts the accuracy of the motion vector of the enhancement layer to an integer position in order for the GRP. In the GRP, the differential coefficient in the reference layer is inducted using the motion vector of the enhancement layer, and in such case, the reference image, after up-sampled, should be interpolated with the accuracy of the motion vector of the enhancement layer. According to an embodiment of the present invention, the extended coder/decoder adjusts the motion vector to the integer position when using the motion vector of the enhancement layer in the GRP, abstaining from additional interpolation of the image of the up-sampled reference layer.

The motion information adjusting unit 650 or 751 determines whether the motion vector of the enhancement layer has been already present at the integer position (1100). In case the motion vector of the enhancement layer has been already at the integer position, no additional adjustment of motion vector is performed. In case the motion vector of the enhancement layer is not at the integer position, mapping 1110 to an integer pixel is performed so that the motion vector of the enhancement layer may be used in the GRP. The coder and decoder performs motion vector integer mapping 1110 based on an algorithm of minimizing errors.

FIG. 11b is a view illustrating an example in which the motion information adjusting unit of the extended coder/decoder maps a motion vector of an enhancement layer to an integer pixel using an algorithm for minimizing errors according to the third embodiment of the present invention.

Referring to FIG. 11b, the motion vector of the enhancement layer may be located at integer positions 1140, 1150, 1160, and 1170 or at non-integer positions 1130. Upon generating a differential coefficient in the reference layer using the motion vector of the enhancement layer in the GRP, the motion vector of the enhancement layer may be used, mapped to an integer pixel, thus omitting the process of additionally interpolating the image of the up-sampled reference layer. The motion vector integer mapping 1110 based on the algorithm of minimizing errors, in case the motion vector of the enhancement layer corresponds to a non-integer position 1130, selects its ambient four integer positions 1140, 1150, 1160, and 1170 as motion vector adjustment candidates. The motion compensation block 1180 is generated for each candidate in the enhancement layer starting from the respective integer positions 1140, 1150, 1160, and 1170 of the candidates. An error 1190 between the motion compensation block 1180 generated for each candidate in the enhancement layer and the block 1185 co-located with the block sought to be coded/decoded in the enhancement layer is calculated in the reference layer, and the candidate with the smallest error is determined as the final motion vector adjusted position. In this case, as an algorithm to measure the error between the two blocks, the SAD (Sum of absolute difference) or the SATD (Sum of absolute transformed difference) may be used, and for transforms in the SATD, the Hadamard transform, DCT (Discrete cosine transform), DST (Discrete sine transform), or the integer transform may be used. Further, to minimize the amount of calculation in measuring the error between the two blocks, only some of the pixels in the blocks, rather than all he pixels, may be measured for errors.

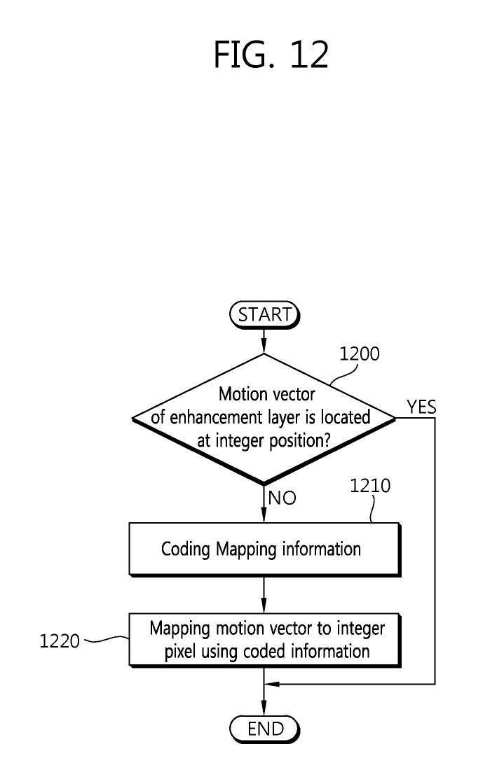

FIG. 12 is a view illustrating another operation of a motion information adjusting unit of an extended coder/decoder according to the third embodiment of the present invention.

Referring to FIG. 12, according to an embodiment of the present invention, the motion information adjusting unit 650 or 751 of the extended coder/decoder adjusts the accuracy of the motion vector of the enhancement layer to an integer position in order for the GRP. In the GRP, the differential coefficient in the reference layer is inducted using the motion vector of the enhancement layer, and in such case, the reference image, after up-sampled, should be interpolated with the accuracy of the motion vector of the enhancement layer. According to an embodiment of the present invention, the extended coder/decoder adjusts the motion vector to the integer position when using the motion vector of the enhancement layer in the GRP, abstaining from additional interpolation of the image of the up-sampled reference layer.

The motion information adjusting unit 650 or 751 determines whether the motion vector of the enhancement layer has been already present at the integer position (1100). In case the motion vector of the enhancement layer has been already at the integer position, no additional adjustment of motion vector is performed. In case the motion vector of the enhancement layer is not at the integer position, the coder encodes the integer position to which to be mapped (1210), and the decoder decodes the mapping information encoded by the encoder (1210). In case the motion vector of the enhancement layer is not at the integer position, the coded mapping information is used to map the motion vector to the integer pixel (1220).

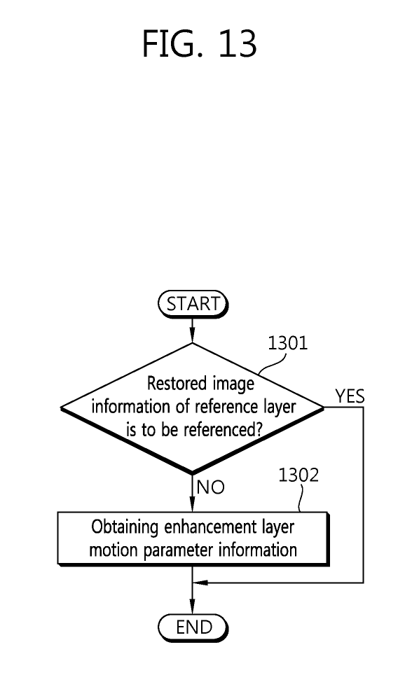

FIG. 13 is a flowchart illustrating an enhancement layer reference information and motion information extracting unit to which the present invention applies.

Referring to FIG. 13, whether the enhancement layer references the restored image of the reference layer is determined (1301), and enhancement layer motion parameter information is obtained (1302).

In case the enhancement layer references the reference layer, the enhancement layer reference information and motion information extracting unit determines whether the enhancement layer references the information of the reference layer and obtains the motion information of the enhancement layer.

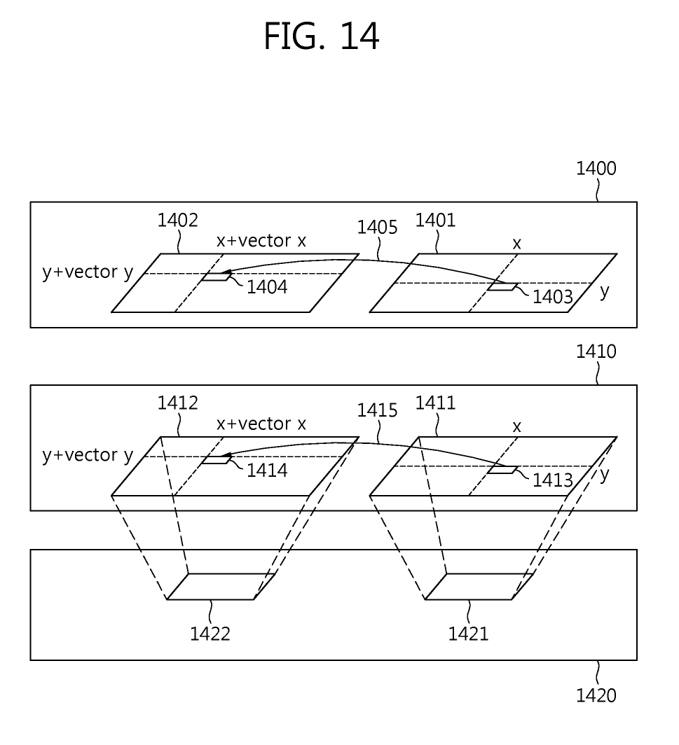

FIG. 14 is a view illustrating an embodiment of the present invention.

Referring to FIG. 14, an enhancement layer 1400, an up-sampled reference layer 1410, and a reference layer 1420 are shown. There are a screen 1401 where a coding process is performed in the enhancement layer, a screen 1402 referenced by the screen where the coding process is performed, a block 1403 with a variable size where coding is currently performed in the screen 1401 where coding is performed in the enhancement layer, and a block 1404 referenced by the block 1403 where coding is currently performed. The block 1403 where coding is currently performed may infer the position of the reference block with the motion vector 1404.

In order for the enhancement layer 1400 to reference the reference layer 1420, the reference layer is up-sampled to a size corresponding to the size of the enhancement layer, creating an up-sampled reference layer image 1410. The up-sampled reference layer image 1410 may include a screen 1411 temporally co-located with the screen where coding is currently performed, a screen 1412 temporally co-located with the screen referenced by the screen where coding is currently performed, a block 1413 spatially co-located with the block 1403 where coding is currently performed, and a block 1414 spatially co-located with the block 1404 referenced by the block 1403 where coding is currently performed. There may be a motion vector 1415 with the same value as the motion vector of the enhancement layer.

The motion vector 1405 of the enhancement layer may have, in some case, an integer pixel position or a non-integer pixel position, a decimal pixel position, and in such case, the same decimal position pixel should be created also in the up-sampled image of the reference layer.

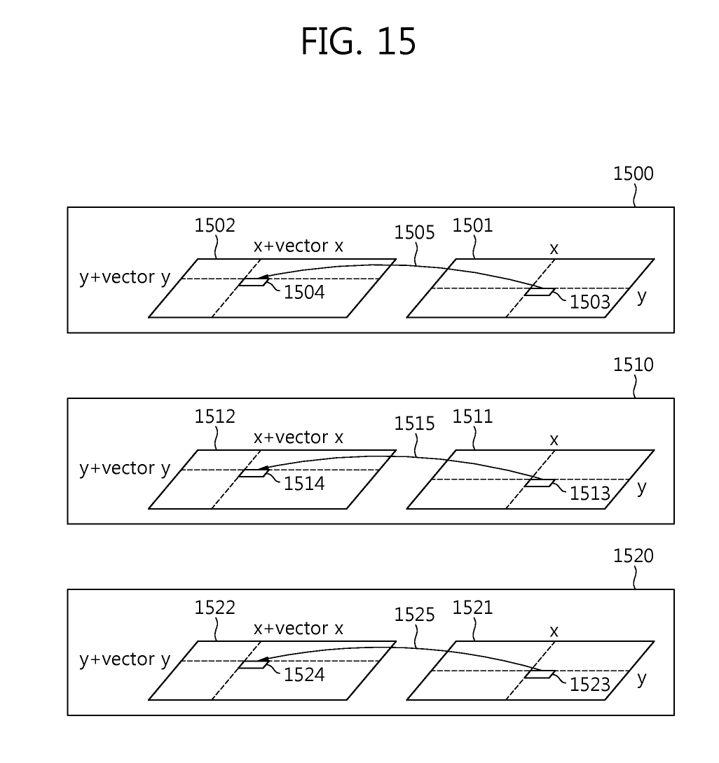

FIG. 15 is a view illustrating another embodiment of the present invention.

Referring to FIG. 15, when the up-sampled reference layer references the motion vector of the enhancement layer, if the motion vector of the enhancement layer is not at an integer position, the motion vector is adjusted to indicate a neighbor integer pixel position. Resultantly, if the motion vector 1505 of the enhancement layer is not at the integer pixel position, the adjusted motion vector 1515 of the up-sampled reference layer and the motion vector of the enhancement layer may have different sizes and directions.

The above-described methods according to the present invention may be prepared in a computer executable program that may be stored in a computer readable recording medium, examples of which include a ROM, a RAM, a CD-ROM, a magnetic tape, a floppy disc, or an optical data storage device, or may be implemented in the form of a carrier wave (for example, transmission through the Internet).

The computer readable recording medium may be distributed in computer systems connected over a network, and computer readable codes may be stored and executed in a distributive way. The functional programs, codes, or code segments for implementing the above-described methods may be easily inferred by programmers in the art to which the present invention pertains.

Although the present invention has been shown and described in connection with preferred embodiments thereof, the present invention is not limited thereto, and various changes may be made thereto without departing from the scope of the present invention defined in the following claims, and such changes should not be individually construed from the technical spirit or scope of the present invention.

1-30. (canceled)

31. A video decoding method, comprising:
restoring an image of a reference layer corresponding to an enhancement layer;
up-sampling the restored image of the reference layer according to a first attribute of the enhancement layer;
storing the up-sampled image in a reference image middle buffer with a pixel depth not down-scaled; and
interpolation-filtering the stored image according to a second attribute of the enhancement layer.

32. The video decoding method of claim 31, wherein said up-sampling includes up-sampling according to a resolution of the enhancement layer.

33. The video decoding method of claim 31, wherein said interpolation-filtering includes interpolation-filtering according to an accuracy of motion compensation of the enhancement layer.

34. The video decoding method of claim 31, further comprising clipping the interpolation-filtered image.

35. The video decoding method of claim 34, wherein a minimum value and a maximum value of the clipping are varied depending on a pixel depth of the enhancement layer.

36. A video decoding method, comprising:
restoring an image of a reference layer corresponding to an enhancement layer;
inducing a prediction coefficient for the enhancement layer based on the restored image;
up-sampling the restored image of the reference layer; and
interpolation-filtering the up-sampled image.

37. The video decoding method of claim 36, wherein the prediction coefficient includes a differential coefficient for the enhancement layer.

38. The video decoding method of claim 36, wherein the prediction coefficient includes a differential coefficient for the reference layer.

39. The video decoding method of claim 36, further comprising adjusting a motion vector accuracy of the enhancement layer on a per-integer pixel basis.

40. The video decoding method of claim 39, further comprising motion-compensating a block for generating a differential coefficient in the up-sampled image based on the motion vector adjusted on a per-integer pixel basis.

41. A video decoding method, comprising:
restoring an image of a reference layer corresponding to an enhancement layer;
adjusting an accuracy for a motion vector of the enhancement layer to an integer position;
up-sampling the restored image of the reference layer; and
storing the up-sampled image in an inter-layer reference image buffer.

42. The video decoding method of claim 41, wherein said adjusting to the integer position includes, mapping to an integer pixel in a case where the motion vector is not at an integer position.

43. The video decoding method of claim 41, wherein said adjusting to the integer position includes, adjusting the motion vector to an integer pixel position located around the non-integer position pixel in a case where the motion vector corresponds to a non-integer position.

44. The video decoding method of claim 41, wherein said adjusting to the integer position includes adjusting the motion vector by using motion vector integer mapping based on an error minimization algorithm.

45. The video decoding method of claim 41, wherein said adjusting to the integer position includes mapping the motion vector to an integer position based on mapping information decoded from a received bitstream.
